(19) United States
(12) Patent Application Publication
(10) Pub. No.: US 2016/0299800 A1
(43) Pub. Date: Oct. 13, 2016

(54) SYSTEM AND METHOD FOR REDUNDANT DATABASE COMMUNICATION

(71) Applicant: EMPIRIX INC., Billerica, MA (US)

(72) Inventors: Michael W. Cleary, Rochester, NH (US); John R. Winsor, Londonderry, NH (US); Harshad R. Thacore, Bedford, MA (US)

(73) Assignee: EMPIRIX INC., Billerica, MA (US)

(21) Appl. No.: 14/680,435

(22) Filed: Apr. 7, 2015

(51) Int. Cl. G06F 11/00; H04L 12/24; H04L 29/08

(52) U.S. Cl. CPC G06F 11/004; H04L 67/1097; H04L 41/0836

(57) ABSTRACT

System and methods for database communication may include servers with network interface controllers (NICs). A server may have multiple of bonded NICs, wherein each NIC has one or more ports, wherein the bonded NICs enable multiple NICs on the server to communicate with the same IP address. Cables may be coupled to the NIC thereby physically connecting each server the other servers, and a closed mesh private network may be created using the bonded NICs. The servers may include a database management system, wherein the servers connected via the closed mesh private network provide database redundancy, and the servers communicate without a network switch for database communication.

### BACKGROUND

### Field of Invention

Embodiments relate to time improved redundancy for database management systems and more generally to database communication.

### SUMMARY

Aspects of the invention may involve systems and methods. In one embodiment of the invention, a method for database communication may include providing a plurality of servers, wherein each server of the plurality of servers includes a plurality of network interface controllers (NICs), each NIC with one or more ports; performing NIC bonding on the plurality of NICs on each server of the plurality of servers; connecting together the plurality of servers; creating a closed mesh private network using the NIC bonding, wherein each server of the plurality of servers communicate with other servers of the plurality of servers; operating a database management system on the plurality of servers; and providing database redundancy using the plurality of servers connected via the closed mesh private network.

In another embodiment, a system for database communication may include a plurality of servers; a plurality of network interface controllers (NICs) coupled to each server of the plurality of servers, wherein each server has a plurality of bonded NICs, wherein each NIC has one or more ports, wherein the bonded NICs enable a plurality of NICs on a server of the plurality of servers to communicate with a same IP address; a plurality of cables coupled to the plurality of NICs, the plurality of cables physically connecting each server of the plurality of servers to other servers of the plurality of servers, wherein the bonded NICs create a closed mesh private network; and a database management system operating on the plurality of servers, wherein the plurality of servers communicating via the closed mesh private network provides database redundancy, wherein the plurality of servers communicate without a network switch for database communication.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 depicts an example server setup using network switches;

FIG. 2 depicts a example server setup using NIC bonding without a network switch;

FIG. 3 depicts an example workflow in an embodiment of the invention; and

FIG. 4 depicts an illustrative embodiment of a computer for performing the methods and building the systems described herein.

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples. The term “network interface controller” or “NIC” may refer to the network controller and may also refer to network ports.

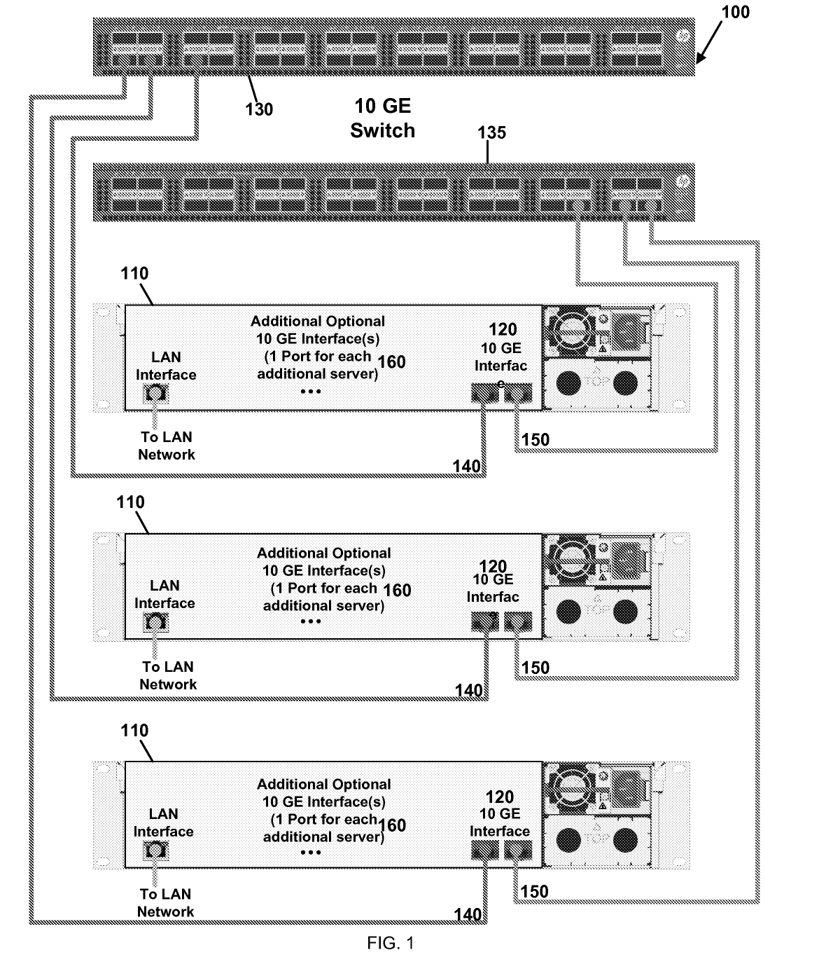

FIG. 1 depicts example server setup 100 using network switches. FIG. 1 includes servers 110, communication ports 120 and 160 (communication ports 120 and 160 may include Ethernet ports and/or NICs), switch 130, second switch 135, cables 140, and cables 150. Each server 110 may include a plurality of network interface controllers (NICs), each NIC may have one or more communication ports.

Servers 110 may include three or more servers. Servers 110 may be configured to execute a database management system. The database management system may include, for example, a column-oriented database such as a Vertica® Cluster by HP®. The database management system may store call and transaction summary records.

Cables 140 may connect each server 110 with switch 130, and provide communication between servers 110. Cables 150 may connect each server 110 with second switch 135 and may provide a redundant (or secondary) communication path between servers 110. Servers 110 may bond ports 120 so that each server 110 may have at least two communication ports with the same network address (e.g., same IP address). If a switch fails (e.g., switch 130 or second switch 135) servers 110 may still communicate without any address reconfiguration to servers 110 or the database management system. Cables 140 and cables 150 may be fiber-optic cables, twinaxial cables, other cable used for communication, or a combination.

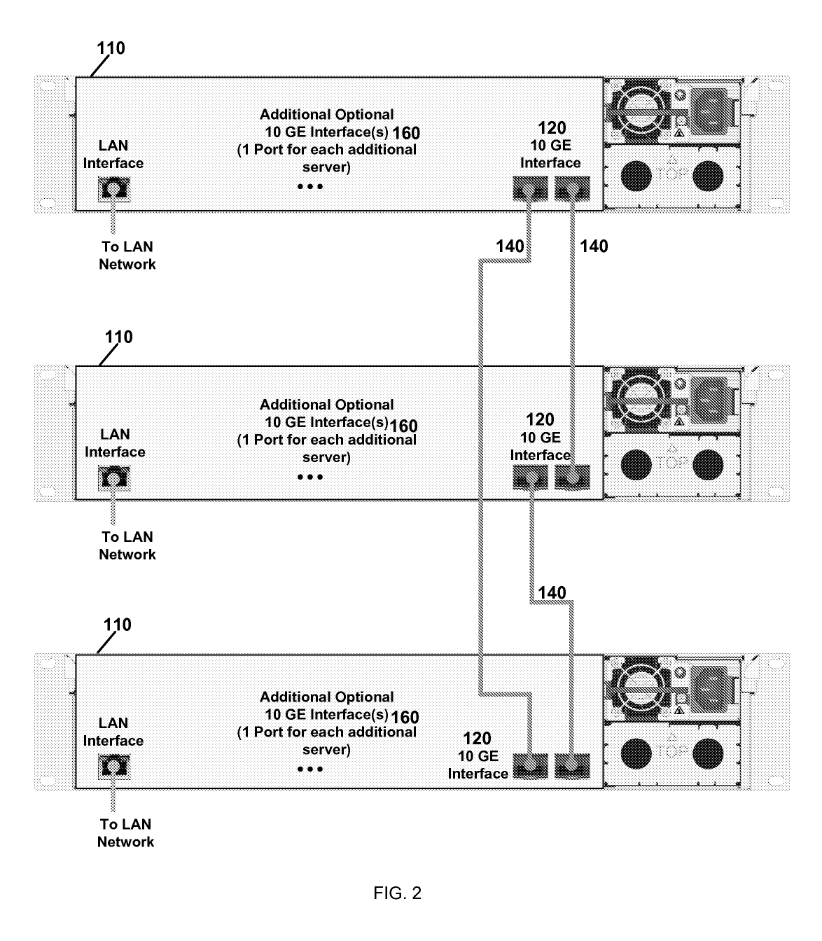

FIG. 2 depicts example server setup 200 using NIC bonding without a network switch. Servers 110 may communicate without the use of a network switch such as switch 130 or second switch 135. Ports 120 on each server 110 may be bonded through NIC bonding so that each server may have at least two communication ports with the same network address (e.g., same IP address). Cables 140 may connect each server 110 to each of the other servers 110.

A closed mesh private network may be created using the NIC bonding, wherein each server of the plurality of servers communicates with other servers of the plurality of servers. A database management system on the plurality of servers may be executed using servers 110. Database redundancy may be achieved using the plurality of servers connected via the closed mesh private network and bonded NICs. Accordingly, servers 110 may communicate without using a network switch for database communication. In one embodiment, servers 110 may communicate using a switch for non-database communication. Although, even the non-database communication may be done without a switch. However, the non-database communication does not use the same closed mesh private network as the database communication.

The removal of switch 130 and second switch 135 reduces a potential point of failure and may improve connectivity between servers 110. Additionally, removal of the switch reduces the number of required cables and, potentially, the length of cables which may also improve efficiency of the connection between the servers. Further, the removal of the switch may improve security. For example, when a network switch is in place there is a risk that someone may access the servers over the IP address defined for the 10 G private link. If a closed mesh is used, for example, then the only servers that can possibly communicate over that link are the servers in the mesh.

In one embodiment, servers 110 may be running a version of Linux as the operating system, and a Linux level configuration of the physical interfaces may be performed to set, for example, eth4 & eth5 to be one bonded NIC in broadcast mode for each of the Vertica® Cluster Nodes.

FIG. 2 depicts three servers 110. However, more than three servers may be used. In one embodiment, for each additional server 110 added, another port or NIC will need to be added to each server 110. So, for each N server, N−1 number of NICs or ports are needed on each server 110 and (N*(N−1))/2 total number of cables 140 may be needed. As shown in example server setup 200, servers 110 may be located very close to each other such as in the same rack. When the servers are close to each other the length of communication cable 140 may be minimized which may provide more efficient communication. Also, the cables would be less prone to damage caused by moving around other equipment (e.g., cables, servers, hardware, etc.) in the rack enclosure where the servers reside.

In another embodiment, servers 110 may not be racked in the same stack. Which may necessitate longer cables with increased risk of damage, for example.

Through NIC bonding on N number of servers 110 and connecting each server 110 to each of the other servers 110 via one of the bonded interfaces, forming N number of connections and one or more closed mesh private networks may be created. The closed mesh private network(s) may be used for high-speed communications and redundant database communication, Such a design provides for both utility and redundancy. Further, such a design may eliminate the need for a switch (e.g., a 10 gigabit per second switch), reducing cost and a point of failure. Additionally, the cable (e.g., 10 G fiber) length may be reduced, reducing the supply cost, and the risk of cable (e.g., fiber) breakage and signal loss.

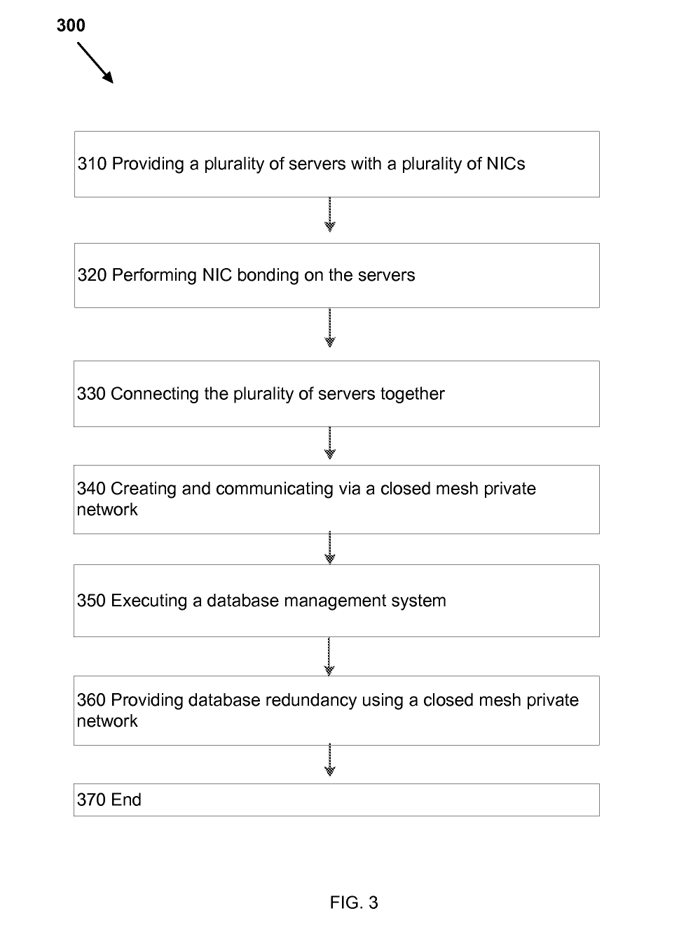

FIG. 3 depicts an example workflow 300. Flow may start at 310. In 310, a plurality of servers 110 may be provided. In one embodiment, each of the servers 110 may have a plurality of network interface controllers (NICs) 120, 160, each NIC may include one or more ports (e.g., Ethernet ports). In one embodiment, the number of servers 110 may be greater than two. The number of NICs or ports on each server 110 may include, for example, the number of servers minus 1. Servers 110 may be racked in the same stack or servers 110 may be racked in different stacks (or a mix of same stack and located remotely from each other). From 310, flow may move to 320.

In 320, NIC bonding may be performed on the plurality of NICs in each server 110. The NIC bonding may be performed at the operating system level and may tie each bonded NIC with the same network address (e.g., the same IP address) used for communication. From 320, flow may move to 330.

In 330, the plurality of servers 110 may be connected to each other using, for example, cables 140 inserted into the ports associated with the NICs on each server. Cables 140 may be fiber-optic cables or twinaxial cables, for example. From 330, flow may move to 340.

In 340, a closed mesh private network using the NIC bonding may be created. Each server 110 may communicate with each of the other servers 110 using the closed mesh private network. From 340, flow may move to 350.

In 350, a database management system may be executed on the plurality of servers 110. The database management system may use, for example, a column-oriented database such as a Vertica® Cluster where each server 110 forms a Vertica® Cluster Node. The database management system may store call and transaction summary records, for example. From 350, flow may move to 360.

In 360, database communication and redundancy may be provided using interconnected servers 110 and the closed mesh private network. Database communication and redundancy may be provided without the use of a network switch 130 or 135. All database communication between servers 110 may be realized without using a network switch.

In one embodiment, non-database communication may utilize a network switch 130. Here, each node may be connected via one of the interfaces 160 to another switch to allow for non-database communication. This switch need not be an expensive 10 G switch, for example. In addition, an external server running a database client may be installed so as to make queries to this cluster. These queries may traverse the switch where the cluster nodes are connected to the 160 interface. However, the non-database communication does not use the same closed mesh private network as the database communication.

Illustrative Computer System

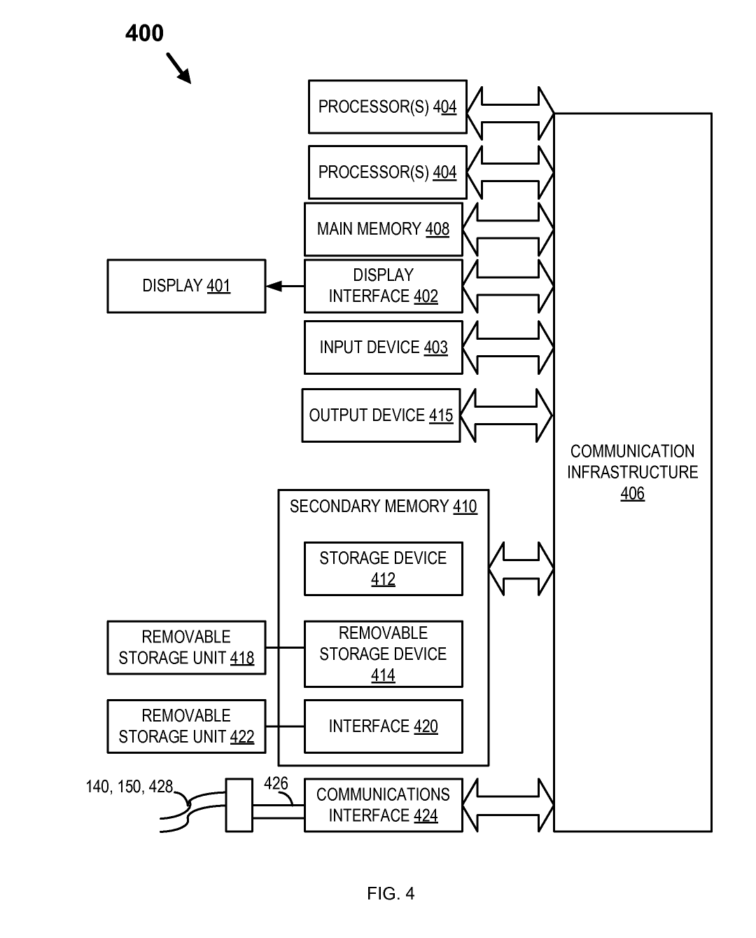

FIG. 4 depicts an illustrative computer system that may be used in implementing an illustrative embodiment of the present invention. Specifically, FIG. 4 depicts an illustrative embodiment of a computer system 400 that may be used in computing devices such as, e.g., but not limited to, standalone or client or server devices. FIG. 4 depicts an illustrative embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 400 is shown in FIG. 4, depicting an illustrative embodiment of a block diagram of an illustrative computer system useful for implementing the present invention. Specifically, FIG. 4 illustrates an example computer 400, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/Windows 8, etc. available from MICROSOFT® Corporation of Redmond, Wash., U.S.A. or an Apple computer or tablet executing MAC® OS, OS X, or iOS from Apple® of Cupertino, Calif., U.S.A., or a computer running a Linux or other UNIX derivative. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 400 is shown in FIG. 4. Other components of the invention, such as, e.g., (but not limited to) a computing device, a communications device, a telephone, a personal digital assistant (PDA), an iPhone, an iPad, a Surface, and Android device, a 3G/4G wireless device, an LTE device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 4. In an illustrative embodiment, services may be provided on demand using, e.g., an interactive television device (iTV), a video on demand system (VOD), via a digital video recorder (DVR), and/or other on demand viewing system. Computer system 400 and/or parts of computer system 400 may be used to implement servers 110, switch 130, and second switch 135, and/or other components as described in FIGS. 1-2 and techniques described in FIG. 3.

The computer system 400 may include one or more processors, such as, e.g., but not limited to, processor(s) 404. The processor(s) 404 may be connected to a communication infrastructure 406 (e.g., but not limited to, a communications bus, cross-over bar, interconnect, or network, etc.). Processor 404 may include any type of processor, microprocessor, or processing logic that may interpret and execute instructions (e.g., for example, a field programmable gate array (FPGA)). Processor 404 may comprise a single device (e.g., for example, a single core) and/or a group of devices (e.g., multi-core). The processor 404 may include logic configured to execute computer-executable instructions configured to implement one or more embodiments. The instructions may reside in main memory 408 or secondary memory 410. Processors 404 may also include multiple independent cores, such as a dual-core processor or a multi-core processor. Processors 404 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

Computer system 400 may include a display interface 402 that may forward, e.g., but not limited to, graphics, text, and other data, etc., from the communication infrastructure 406 (or from a frame buffer, etc., not shown) for display on the display unit 401. The display unit 401 may be, for example, a television, a computer monitor, iPad, a mobile phone screen, etc. The output may also be provided as sound through, for example, a speaker.

The computer system 400 may also include, e.g., but is not limited to, a main memory 408, random access memory (RAM), and a secondary memory 410, etc. Main memory 408, random access memory (RAM), and a secondary memory 410, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 410 may include, for example, (but is not limited to) a hard disk drive 412 and/or a removable storage drive 414, representing a floppy diskette drive, a magnetic tape drive, an optical disk drive, a compact disk drive CD-ROM, flash memory, etc. The removable storage drive 414 may, e.g., but is not limited to, read from and/or write to a removable storage unit 418 in a well-known manner. Removable storage unit 418, also called a program storage device or a computer program product, may represent, e.g., but is not limited to, a floppy disk, magnetic tape, optical disk, compact disk, etc. which may be read from and written to removable storage drive 414. As will be appreciated, the removable storage unit 418 may include a computer usable storage medium having stored therein computer software and/or data.

In alternative illustrative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 422 and interfaces 420, which may allow software and data to be transferred from the removable storage unit 422 to computer system 400.

Computer 400 may also include an input device 403 which may include any mechanism or combination of mechanisms that may permit information to be input into computer system 400 from, e.g., a user. Input device 403 may include logic configured to receive information for computer system 400 from, e.g. a user. Examples of input device 403 may include, e.g., but not limited to, a mouse, pen-based pointing device, or other pointing device such as a digitizer, a touch sensitive display device, and/or a keyboard or other data entry device (none of which are labeled). Other input devices 403 may include, e.g., but not limited to, a biometric input device, a video source, an audio source, a microphone, a web cam, a video camera, a light-sensitive device, and/or other camera. Still other input devices 403 may include, e.g., but not limited to, an imaging device, a light-sensitive device, sensing elements, accelerometers, gyroscopes, and/or magnetometers.

Computer 400 may also include output devices 415 which may include any mechanism or combination of mechanisms that may output information from computer system 400. Output device 415 may include logic configured to output information from computer system 400. Embodiments of output device 415 may include, e.g., but not limited to, display 401, and display interface 402, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 400 may include input/output (I/O) devices such as, e.g., (but not limited to) input device 403, communications interface 424, cable 428, 140, 150 and communications path 426, etc. These devices may include, e.g., but are not limited to, a network interface controller (NIC) 120 and 160, and/or modems.

Communications interface 424 may allow software and data to be transferred between computer system 400 and external devices.

In this document, the terms “computer program medium” and “computer readable medium” may be used to generally refer to media such as, e.g., but not limited to, removable storage drive 414, a hard disk installed in hard disk drive 412, memory unit, flash memories, removable discs, non-removable discs, etc. In addition, it should be noted that various electromagnetic radiation, such as wireless communication, electrical communication carried over an electrically conductive wire (e.g., but not limited to twisted pair, CAT5, etc.) or an optical medium (e.g., but not limited to, optical fiber) and the like may be encoded to carry computer-executable instructions and/or computer data that embodiments of the invention on e.g., a communication network. These computer program products may provide software to computer system 400. It should be noted that a computer-readable medium that comprises computer-executable instructions for execution in a processor may be configured to store various embodiments of the present invention. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may. The various embodiments described herein may be combined and/or features of the embodiments may be combined to form new embodiments.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. A general purpose computer may be specialized by storing programming logic that enables one or more processors to perform the techniques indicated herein and the steps of or descriptions shown in, for example, FIG. 3.

Embodiments of the present invention may include apparatuses for performing the operations herein. An apparatus may be specially constructed for the desired purposes, or it may comprise a general purpose device selectively activated or reconfigured by a program stored in the device.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents.

What is claimed is:

1. A method for database communication comprising:
providing a plurality of servers, wherein each server of the plurality of servers includes a plurality of network interface controllers (NICs), each NIC with one or more ports;
performing NIC bonding on the plurality of NICs on each server of the plurality of servers;
connecting together the plurality of servers;
creating a closed mesh private network using the NIC bonding, wherein each server of the plurality of servers communicate with other servers of the plurality of servers;
operating a database management system on the plurality of servers; and
providing database redundancy using the plurality of servers connected via the closed mesh private network.

2. The method of claim 1, wherein the plurality of servers comprises N number of servers, wherein N>=3, each of the N servers comprises at least N−1 number of NICs, and each server of N servers communicates to N−1 other servers.

3. The method of claim 2, wherein the N servers are connected together with (N*(N−1))/2 number of cables.

4. The method of claim 3, wherein the cables are fiber-optic cables or twinaxial cables.

5. The method of claim 1, wherein the plurality of servers communicate without a network switch for database communication.

6. The method of claim 5, wherein the plurality of servers communicate using a switch for non-database communication.

7. The method of claim 1, wherein the database management system is a column-oriented database management system.

8. The method of claim 1, wherein the plurality of servers are racked in a same stack.

9. The method of claim 1, wherein the plurality of servers are not racked in a same stack.

10. The method of claim 1, wherein the NIC bonding enables a plurality of NICs on a server of the plurality of servers to be identified with a same IP address.

11. The method of claim 1, wherein the database management system stores call and transaction summary records.

12. A system for database communication comprising:
a plurality of servers;
a plurality of network interface controllers (NICs) coupled to each server of the plurality of servers, wherein each server has a plurality of bonded NICs, wherein each NIC has one or more ports, wherein the bonded NICs enable a plurality of NICs on a server of the plurality of servers to communicate with a same IP address;
a plurality of cables coupled to the plurality of NICs, the plurality of cables physically connecting each server of the plurality of servers to other servers of the plurality of servers, wherein the bonded NICs create a closed mesh private network; and
a database management system operating on the plurality of servers, wherein the plurality of servers communicating via the closed mesh private network provides database redundancy, wherein the plurality of servers communicate without a network switch for database communication.

13. The system of claim 12, wherein the plurality of servers comprises N number of servers, wherein N>=3, each of the N servers comprises at least N−1 number of NICs, and each of the N servers communicates to N−1 other servers.

14. The system of claim 13, wherein the N servers are connected together with (N*(N−1))/2 number of cables.

15. The system of claim 12, wherein the plurality of cables are fiber-optic cables or twinaxial cables.

16. The system of claim 12, wherein the plurality of servers communicate using a switch for non-database communication.

17. The system of claim 12, wherein the database management system is a column-oriented database management system.

18. The system of claim 12, wherein the plurality of servers are racked in a same stack.

19. The system of claim 12, wherein the plurality of servers are not racked in a same stack.

20. The system of claim 12, wherein the database management system stores call and transaction summary records.
